(19) United States
(12) Patent Application Publication
(10) Pub. No.: US 2002/0026302 A1
(43) Pub. Date: Feb. 28, 2002

(54) Automatic evaluation method, automatic evaluation system, and storage medium storing automatic evaluation program

(76) Inventor: Kazuyoshi Takeda, Chino-shi (JP)

Correspondence Address: HARNESS, DICKEY & PIERCE, PLC, P.O. BOX 828, BLOOMFIELD HILLS, MI, 48303, US

(21) Appl. No.: 09/881,195

(22) Filed: Jun. 14, 2001

(30) Foreign Application Priority Data
Jun. 14, 2000 (JP) 2000-178341(P)

(51) Int. Cl. G06F 9/455

(52) U.S. Cl. 703/19

(57) ABSTRACT

A highly reliable automatic evaluation is realized by constructing a mechanism which causes a simulator to monitor a regular cycle in which a result of a simulation becomes definite and a screen is renewed, and notifies this to an automatic evaluation unit.

An automatic evaluation system automatically evaluates a program operating on a target system by referring to an output screen as a result of a simulation to an arbitrary input event, in which a simulation unit 30 performs the simulation of an operation of the program and monitors a timing when data renewal of the output screen on which its result is reflected becomes definite, and an automatic evaluation unit 11 obtains the timing when the data renewal of the output screen becomes definite from the simulation unit 30, refers to the output screen at the timing, and carries out an automatic evaluation by comparing a result of the reference with reference data prepared in advance.

### TECHNICAL FIELD

The present invention relates to an automatic evaluation method, an automatic evaluation system, and a storage medium storing an automatic evaluation program, which can automatically evaluate a program operating on a target system from an input event such as a key input and a reference output resulting from this input event on, for example, output screen.

### BACKGROUND ART

In recent years, microcomputers have been installed and widely used in various devices such as electrical domestic appliances. For the purpose of operating the microcomputer in accordance with the specification of the device in which it is installed, such as a peripheral device or the like, an application program is written in a built-in ROM (Read Only Memory). Liquid crystal display devices (hereinafter referred to as an LCD: Liquid Crystal Display) are also installed in various devices such as electrical domestic appliances. Thus, when an input event such as a key input by a user is inputted, the microcomputer causes an output screen corresponding to this input event to be outputted onto the LCD by the application program. Then, in the case where the operation of the application program of the microcomputer is recognized, the microcomputer must recognize output results from a number of input events corresponding to the specifications of the installation device.

Thus, in the development of the microcomputer, the development of the application program, together with the development of the hardware, is also important. In the development of the application program, an in-circuit emulator (hereinafter referred to as an ICE: In Circuit Emulator) or the like is used. The ICE can emulate the operation of the application program on a target board. As described above, in the operation confirmation of the application program, there are a number of input events to be confirmed. Thus, in the case where the operator directly inputs the input events by using the ICE, it takes a long time to input and there is also a possibility that the operator makes an input mistake. Besides this, in the case where the operator confirms the input event and the emulation result through the screen output or the like, it takes a long time and there is a possibility that the operator makes a confirmation mistake. Further, in the evaluation of the application program by this operation confirmation, the evaluation for the same input event is repeated in order to improve the evaluation system. Then, in order to make the operation confirmation of the application program with high accuracy and efficiently, an automatic evaluation system is used in which a number of input events can be repeatedly and automatically inputted, and output results of the input events are automatically evaluated.

According to the foregoing automatic evaluation system, the application program operating on the target system can be automatically evaluated by using simulation results of a simulation unit. Thus, it is necessary to provide a memory which can be commonly accessed by the automatic evaluation system and the simulation unit, and by this, access between the automatic evaluation system and the simulation unit becomes possible. At this time, the simulation unit carries out normal processing to perform a simulation of an input event and to output its simulation result. Accordingly, it is not necessary to incorporate any procedures for automatic evaluation in the application program.

In the foregoing automatic evaluation system, it is necessary that an input event file be prepared in advance, and reference data corresponding to the input event file be prepared. Then, an input event is successively transmitted to the simulator, result data is received by referring to the display screen (display memory) on which the result of the simulation is reflected, and the result is compared with the reference data prepared in advance so that the automatic evaluation is carried out.

Actually, there are certain types of data in which, even if a key input is not actually made, the display screen is rewritten. That is, for example, there is a blinking cursor or a character moving around on the screen, and this is an input event other than a key input. In this way, in the case where the application program operating on the target program arbitrarily rewrites the screen content, and in the case where the automatic evaluation system reads this at a suitable timing, an accurate automatic evaluation cannot be carried out. Accordingly, in order to obtain a highly reliable evaluation, it is necessary that the automatic evaluation system reads display screen data at a timing when the result of the simulation becomes definite and rewriting of the screen is completed.

The present invention has been made in view of the above circumstances and has an object to provide an automatic evaluation method, an automatic evaluation system, and a storage medium storing an automatic evaluation program, in which a highly reliable automatic evaluation is realized by constructing a mechanism which causes a simulator to monitor a regular cycle in which a result of a simulation becomes definite and a screen is updated, and which notifies this to an automatic evaluation unit.

### DISCLOSURE OF THE INVENTION

In order to solve the above problems, an automatic evaluation method as set forth in claim 1 is an automatic evaluation method for automatically evaluating a program operating on a target system by referring to an output screen as a result of a simulation to an arbitrary input event, in which the simulation is performed, a timing when data renewal of the output screen on which its result is reflected becomes definite is reported, reference to the output screen is made in accordance with the timing, and a result of the reference is compared with reference data prepared in advance, so that an automatic evaluation is carried out.

According to the automatic evaluation method, the result data of the simulation can be captured only at the timing when the simulation result becomes definite, in any state. Accordingly, stable reference data can be obtained, and an evaluation having a high reliability becomes possible by this.

Further, according to an automatic evaluation method as set forth in claim 2, in the method as set forth in claim 1, the timing when the data renewal of the output screen becomes definite is determined by monitoring the passage of a predetermined time defined in advance. Moreover, according to an automatic evaluation method as set forth in claim 3, in the method as set forth in claim 1, the timing when the data renewal of the output screen becomes definite is determined by data which is finally prepared by carrying out a logical sum operation of individual simulation results at predetermined time intervals. Moreover, according to an automatic evaluation method as set forth in claim 4, in the method as set forth in claim 1, the timing when the data renewal of the output screen becomes definite is reported by a display rewriting completion event from the program operating on the target system.

According to these automatic evaluation methods, the timing when the screen rewriting is completed can be detected, and by this, the automatic evaluation system knows when the result of the simulation becomes definite, and a highly reliable evaluation can be realized by referring to the output screen.

Besides this, according to an automatic evaluation method as set forth in claim 5, in the method as set forth in any one of claims 1 to 4, the simulation is stopped when reference to the output screen is made.

According to this automatic evaluation method, since the simulation is stopped when reference to the output screen is made, the data of the output screen is not renewed by the simulation. Accordingly, it is possible to reliably refer to the output screen on which the data becomes definite.

In order to solve the above problems, an automatic evaluation system as set forth in claim 6 is an automatic evaluation system for automatically evaluating a program operating on a target system by referring to an output screen as a result of a simulation corresponding to an arbitrary input event, and comprises a simulation unit for performing the simulation of an operation of the program and monitoring a timing when data renewal of the output screen on which its result is reflected becomes definite, and an automatic evaluation unit for obtaining from the simulation unit the timing when the data renewal of the output screen becomes definite, referring to the output screen at the timing, and carrying out an automatic evaluation by comparing a result of the reference with reference data prepared in advance.

According to the automatic evaluation system, the simulation unit can capture the result data of the simulation from the simulation unit only at the timing when the simulation result becomes definite even in any state. Accordingly, stable reference data can be obtained, and an evaluation having high reliability becomes possible by this.

Further, according to an automatic evaluation system as set forth in claim 7, in the system as set forth in claim 6, the simulation unit comprises a simulator for performing the simulation, and a timing monitor portion for obtaining the timing when the data renewal of the output screen becomes definite by communicating with the simulator.

According to this automatic evaluation system, the timing monitor portion obtains the timing when the data renewal of the output screen becomes definite and can notify the automatic evaluation unit, and the automatic evaluation unit can capture the result data only at the timing when the result of the simulation by the simulator becomes definite. Accordingly, high-reliability evaluation becomes possible.

Besides this, according to an automatic evaluation system as set forth in claim 8, in the system as set forth in claim 7, the timing monitor portion includes a timer for monitoring passage of a predetermined time defined in advance. Besides this, according to an automatic evaluation system as set forth in claim 9, in the system as set forth in claim 7, the timing monitor portion includes an arithmetic logic unit for carrying out a logical sum operation of individual simulation results at predetermined time intervals and a determination according to the finally prepared data. Moreover, according to an automatic evaluation system as set forth in claim 10, in the system as set forth in claim 7, the timing monitor portion includes a decoder which receives a display rewriting completion event from the program operating on the target system and decodes the display rewriting completion event.

According to these automatic evaluation systems, the timing when the screen rewriting is completed can be detected, and by this, the automatic evaluation system can know that the result of the simulation becomes definite, and a highly reliable evaluation can be realized by referring to the output screen.

Besides, according to an automatic evaluation system as set forth in claim 11, in the system as set forth in any one of claims 6 to 10, the simulation is stopped when the reference to the output screen is made.

According to this automatic evaluation system, since the simulation is stopped when the reference to the output screen is made, the data of the output screen is not renewed by the simulation. Accordingly, it is possible to reliably refer to the output screen on which the data becomes definite.

In order to solve the above problems, a storage medium storing an automatic evaluation program as set forth in claim 12 is a storage medium storing an automatic evaluation program for automatically evaluating a program operating on a target system by referring to an output screen as a result of a simulation to an arbitrary input event, in which the automatic evaluation program comprises a step of reading input events and reference data prepared in advance for the individual input events, a step of successively transmitting the read input events to cause execution of the simulation, a step of obtaining a notification of a timing when data renewal of the output screen on which a result of the simulation is reflected becomes definite and referring to the output screen in accordance with the timing, and a step of carrying out an automatic evaluation by comparing a result the reference with the reference data.

According to the storage medium storing the automatic evaluation program, the automatic evaluation can be carried out by using the simulation result of a simulator to the input event, and at this time, the automatic simulation system can capture the result data of the simulation only at the timing when the simulation result becomes definite even in any state.

Accordingly, stable reference data can be obtained, and an evaluation having high reliability becomes possible by this. Especially, a case where reference to simulation data is made during inversion of a blinking cursor or the like does not occur, and as a result, stability in the automatic evaluation is secured.

### BRIEF DESCRIPTION OF THE DRAWINGS

FIG. 1 shows the structure of a personal computer in which an automatic evaluation system according to an embodiment is operated.

FIG. 2 is a view for explaining the access between the automatic evaluation system according to the embodiment and a simulator.

FIG. 3 is a view showing an example of an input event and a reference output result.

FIG. 4 is a function development view of a personal computer for realizing an automatic evaluation method in the automatic evaluation system according to the embodiment.

FIG. 5 is a flowchart of the automatic evaluation method according to the embodiment.

### BEST MODE FOR CARRYING OUT THE INVENTION

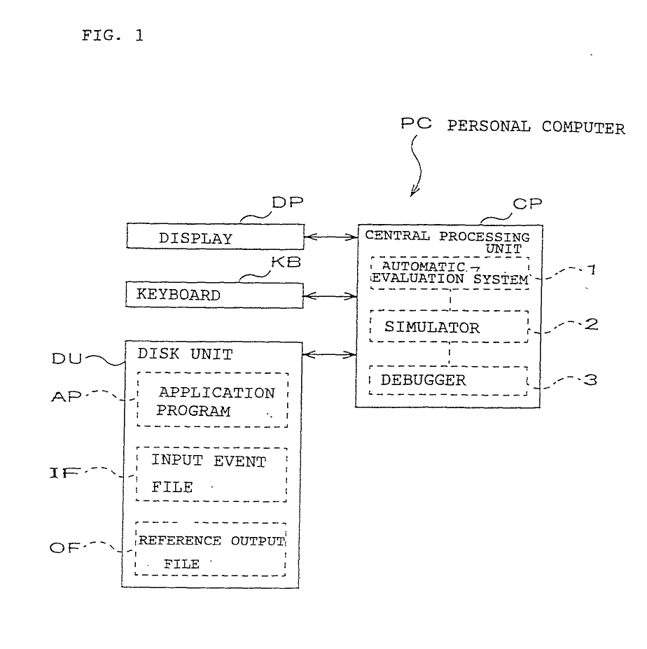

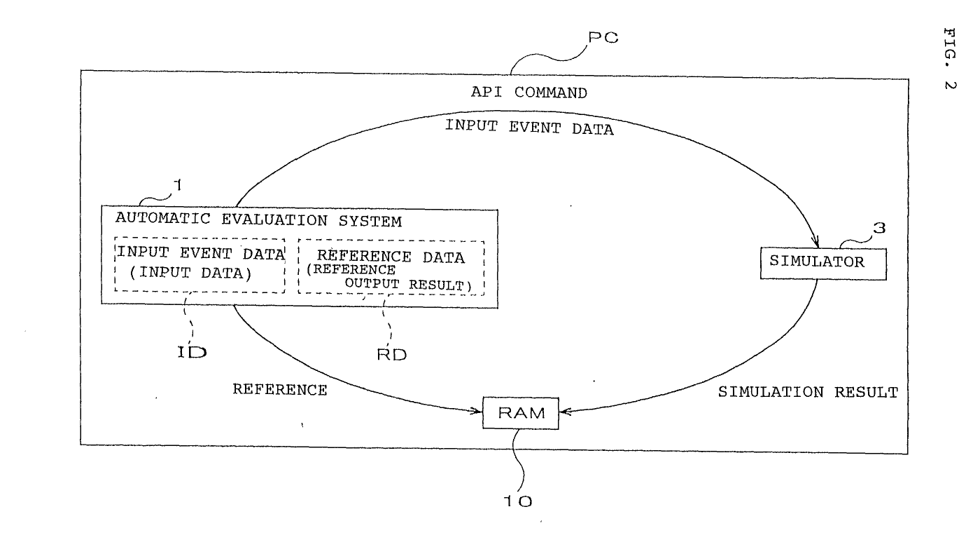

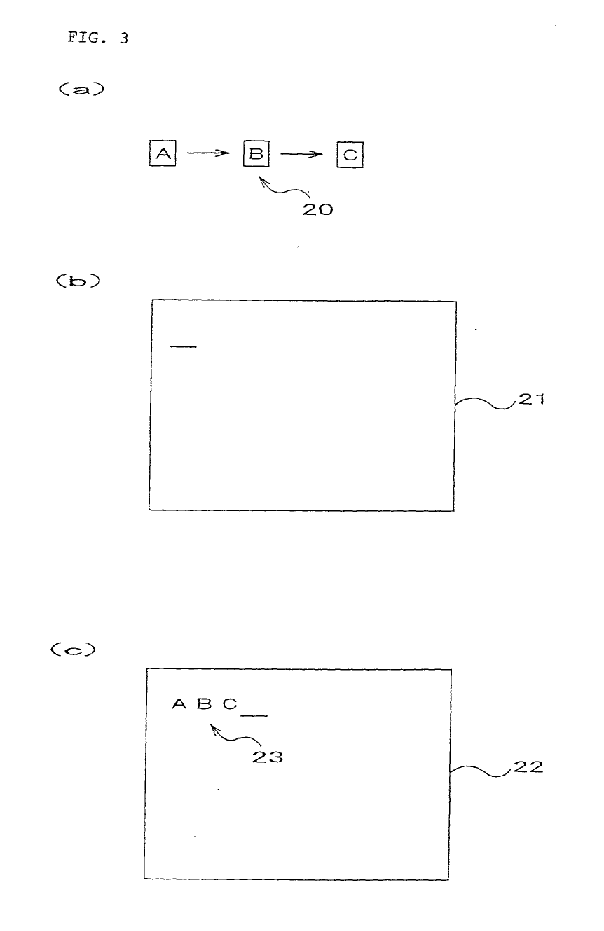

Hereinafter, embodiments of an automatic evaluation method of the present invention, an automatic evaluation system, and a storage medium storing an automatic evaluation program will be described with reference to the drawings. FIG. 1 is a structural view of a personal computer in which an automatic evaluation system and a simulator are operated, FIG. 2 is a view for explaining the form of access between the automatic evaluation system and the simulator, and FIG. 3 is a view showing an example of an input event and a reference output result, in which (a) shows a key input, (b) shows a reference output screen of an LCD before the key input in view (a), and (c) shows the reference output screen of the LCD to the key input of view (a).

According to the automatic evaluation system and method of the present invention, an application program operating on a target system can be automatically evaluated by using a simulation result of a simulator. At this time, the simulator carries out a normal processing to perform a simulation corresponding to an input event and to output the simulation result. Thus, it is not necessary to incorporate a function for automatic evaluation in the application program. Further, in this automatic evaluation system and the automatic evaluation method, result data of the simulation can be captured only with a timing corresponding to when the simulation result becomes definite, in any state. Besides this, in the storage medium storing the automatic evaluation program according to the present invention, the automatic evaluation program is loaded into an electronic computer through this storage medium and is executed, so that the automatic evaluation system of the present invention can be constructed, and the automatic evaluation by the automatic evaluation method of the present invention can be realized.

Incidentally, the target system is, for example, a microcomputer operating on the basis of the application program. The input event is set corresponding to the specifications of the device in which the target system is installed, and the target input event differs depending on the input means of the installation device. The objective input event is, for example, a key input, a voice input or the like. The reference output result is a normal output of the target system to the input event, and is set corresponding to the specifications of the device in which the target system is installed, and the target reference output result differs depending on the output means of the installation device. The target reference output result is a screen output, a voice output, or the like.

In the embodiment of the present invention, the automatic evaluation system is constructed as an automatic evaluation system in which an automatic evaluation program is loaded into a personal computer through a storage medium storing the automatic evaluation program, and the operations of the automatic evaluation program are executed in the personal computer to carry out automatic evaluation. Further, in order to capture an input event and a reference output result, the automatic evaluation system uses a disk unit connected to the personal computer. Besides, in the embodiment of the present invention, the simulator is constructed as a simulation unit in which a simulation program is loaded into the personal computer through a storage medium storing the simulation program, and the operations of the simulation program are executed by the personal computer to perform simulation. Incidentally, the automatic evaluation system and the simulator are constructed in the same personal computer. Besides, in the embodiment of the present invention, the target system is a microcomputer. Further, in the embodiment of the present invention, the microcomputer is installed in a device in which external key (button) input is possible and the screen output is made onto an LCD, such as a game, a watch, or a data bank.

First, the whole structure of an automatic evaluation system 1 and a simulator 3 will be described with reference to FIG. 1. In the automatic evaluation system 1, an automatic evaluation program is read from a storage medium storing the automatic evaluation program on a disk unit DU of a personal computer PC, and further, the automatic evaluation program is loaded into a main storage unit and is executed by a central processing unit CP (including the main storage unit) to carry out automatic evaluation. Incidentally, the disk unit DU is a unit which supports a storage medium such as a floppy disk or an optical disk and can read and write. The automatic evaluation system 1 reads an input event stored in an input event file IF through the disk unit DU, and transmits this input event to the simulator 3. Further, the automatic evaluation system 1 reads a reference output result stored in a reference output file OF through the disk unit DU, and compares it with a simulation result of the simulator 3 corresponding to the input event to carry out automatic evaluation.

Incidentally, the automatic evaluation system 1 stores the evaluation results as a result log file in the disk unit DU or makes a screen output onto a display DP.

In the simulator 3, a simulation program is read from a storage medium storing the simulation program on the disk unit DU of the personal computer PC, and further, the simulation program is loaded into the main storage unit and is executed in the central processing unit CP to perform simulation. Besides this, the simulator 3 reads an application program AP of a microcomputer through the disk unit DU, and simulates the operation of this application program AP.

When the input event is transmitted from the automatic evaluation system 1, the simulator 3 simulates the operation of the application program AP on the basis of this input event. Then, the simulator 3 stores the simulation result in a RAM (Random Access Memory) 10 which is assigned to a part of the main storage unit of the personal computer PC as a shared memory accessed by the automatic evaluation system 1 of the present invention and the simulator 3 (see FIG. 2).

In the simulator 3, an external operation a keyboard KB corresponding to the key input of the installation device is possible, and the LCD screen is outputted onto the display DP corresponding to the screen output of the LCD of the installation device.

Incidentally, here, the simulator 3 is connected to a debugger 2 to debug the application program AP in order that debugging be executed while the simulation is performed. In the debugger 2, a debugging program is read from a storage medium storing the debugging program on the disk unit DU of the personal computer PC, is loaded into the main storage unit, and is executed by the central processing unit CP to perform debugging. The debugger 2 can start/stop the simulator 3, refer to data or rewrite data on the simulator 3, and the like. Further, the debugger 3 can execute or break the application program AP at every step.

Here, the input event file IF and the reference output file OF will be described. The input event file IF and the reference output file OF are prepared by using an input event data preparation function and a reference data preparation function of the automatic evaluation system 1, or are prepared by an editor in advance.

A description will be given of a case where the input event file IF is prepared by the automatic evaluation system 1. First, the individual keys of the installation device of the microcomputer are assigned to the individual keys of the keyboard KB by the automatic evaluation system 1. The user prepares a number of input events corresponding to the specification of the installation device, and inputs the keys one by one. By this, the automatic evaluation system 1 determines the kind of key and the input sequence as input event data for each input event. Finally,the automatic evaluation system 1 stores the input event data of all input events in the input event file IF.

Incidentally, the input event file IF is given an arbitrary file name and is stored in the storage medium, and is set in a state where it can be read from the disk unit DU. In this connection, the input event file IF can be changed corresponding to changes in the specifications of the microcomputer, changes in the specifications of the installation device, changes in the evaluation contents, and the like. For example, as shown in the view (a) of FIG. 3, it is assumed that key operations are performed in the order: pressing an [A] key, a [B] key and a [C] key. In this case, for an input event 20, as input event data, the kinds of A, B and C keys and the input order of the keys are stored as input event data in the input event file IF.

Next, a description will be given of a case where the reference output file OF is prepared by the automatic evaluation system 1. Since reference data in which one reference output result is made to correspond to one input event is stored in the reference output file OF, it is prepared corresponding to the preparation of the input event file IF. Every time the user inputs a key as an input event, the automatic evaluation system 1 transmits the key input as the input event to the simulator 3. Then, the simulator 3 performs a simulation for this key input, and displays a simulation result on the display DP. After being displayed, the user confirms the display content of the display DP, and if correct, it becomes definite as the reference output result. In this connection, according to the embodiment of the present invention, since output means of the installation device is the LCD, the reference output result (reference data) is image data for the display of the LCD and position data of the display on the LCD.

Incidentally, in the case where the application program AP is in the middle of development, the reference output file OF is prepared according to upgrading the application program AP. At this time, it is assumed that in the reference output file OF, a bug correction portion of the application program AP, a specification change portion and the like are added to the automatic evaluation items, and the automatic evaluation including the changed portions of the application program AP can be carried out. Alternatively, after the user inputs the key of one input event, the image data for the display of the LCD may be prepared as the reference output result by a reference data preparation editor of the automatic evaluation system 1.

Finally, the automatic evaluation system 1 stores the reference data of all reference output results in the reference output file OF. The reference output file OF is given an arbitrary filename and is stored in the storage medium, and is set in a state where it can be read out from the disk unit DU. The filename of the reference output file OF is described in the input event file IF, and it is read out in accordance with the input event file IF. Accordingly, the reference output file OF is changed corresponding to the input event file IF. For example, as shown in the view (b) of FIG. 3, it is assumed that before the input event 20 is inputted, [_] is displayed at the upper left end on a reference output screen 21 of the LCD. Then, as the input event 20, when the key input of view (a) is performed, as shown in view (c), [ABC_] is displayed as a reference output result 23 from the upper left end to the right on a reference output screen 22 of the LCD. In this case, with respect to the reference output result 23, the image data for the display of the LCD of [ABC_] and the display position data on the LCD screen are stored as the reference data in the reference output file OF.

Next, with reference to FIGS. 1 and 2, the operation of the automatic evaluation system 1 and the simulator 3 when the automatic evaluation is carried out, will be described.

When the automatic evaluation system 1 is started by the user, the input event data ID stored in the input event file IF is loaded from the disk unit DU into the personal computer PC. Incidentally, the input event file IF is specified by means of a filename supplied by the user. When the input event data ID is loaded, the automatic evaluation system 1 loads the reference data RD stored in the reference output file OF of the filename described in the input event file IF into the personal computer PC.

Then, the automatic evaluation system 1 transmits one input event from the input event data ID to the simulator 3. API (Application Programming Interface) commands of the OS (Operating System) of the personal computer are used for the transmission of the input event. For example, in the case where the OS is Windows 98, the API command FindWindow is used to obtain a window handle of the simulator 3. Then, the API command PostMessage is used and one input event in the input event data ID is transmitted to the window handle. That is, the transmission of the input event is enabled between the automatic evaluation system 1 and the simulator 3 by the API commands. In this connection, since the automatic evaluation system 1 and the simulator 3 use functions provided in the OS, such as the API commands, it is not necessary to particularly add a function to transmit the input event.

Every time the input event is transmitted, the simulator 3 simulates the operation of the application program AP on the basis of this input event. Then, in order to carry out a display on the display DP, the simulator 3 temporarily stores the image data for the display of the LCD and the position data as the simulation result in a RAM 10. In this connection, the simulator 3 also displays the image data for the display of the LCD stored in the RAM 10 on the display DP. In this connection, the processing of the simulator 3 performed here is normally the same as the processing for the simulation of the operation of the application program AP, and a special processing is not performed for carrying out the automatic evaluation. Accordingly, as the application program AP, the same one as an application program actually installed in the microcomputer can be used.

Incidentally, the RAM 10 is the main storage unit of the personal computer PC, and is constructed by a RAM which can be shared by the automatic evaluation system 1 and the simulator 3. Accordingly, the RAM 10 can be accessed by the automatic evaluation system 1 and the simulator 3. That is, the simulation result can be exchanged between the automatic evaluation system 1 and the simulator 3 through the RAM 10. In this connection, since the automatic evaluation system 1 and the simulator 3 use the RAM 10 of the personal computer PC, it is not necessary to add a special function to refer to the simulation result. Incidentally, the RAM 10 may be a VRAM (Video RAM) included in the personal computer.

After the simulation, the automatic evaluation system 1 refers to the simulation result stored in the RAM 10. Then, the automatic evaluation system 1 compares the simulation result with the reference data (the image data for the display of the LCD and the position data) as the reference output result corresponding to the input event transmitted to the simulator 3 in the loaded reference data RD. The automatic evaluation system 1 determines whether both results agree with each other, and evaluates the operation of the application program AP from the input event. Further, the automatic evaluation system 1 stores this determination result in the result log file. All the determination results may be stored in the result log file, or the determination results may be stored only in the case where the simulation results and-the reference output results are different from each other.

Incidentally, the automatic evaluation system 1 may display the simulation result and the reference output result side by side on the display DP in a state that the user can check. Also, the automatic evaluation system 1 may display the determined results on the display DP.

Each time the evaluation of one input event is ended, the automatic evaluation system 1 repeats the foregoing processing for the next input event stored in the input event data ID and carries out the automatic evaluation. Then, the evaluation for all input events of the input event data ID ends, the automatic evaluation system 1 stores the result log file in the storage medium such as a hard disk in accordance with the instructions of the user, and ends the automatic evaluation.

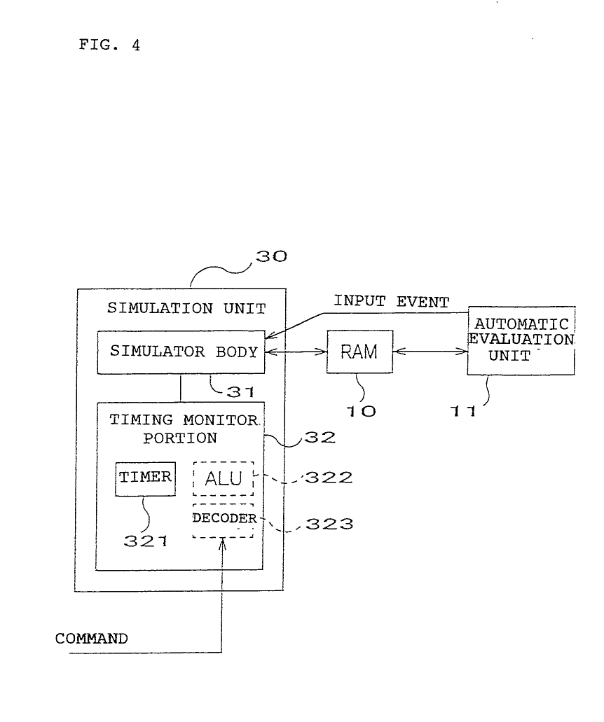

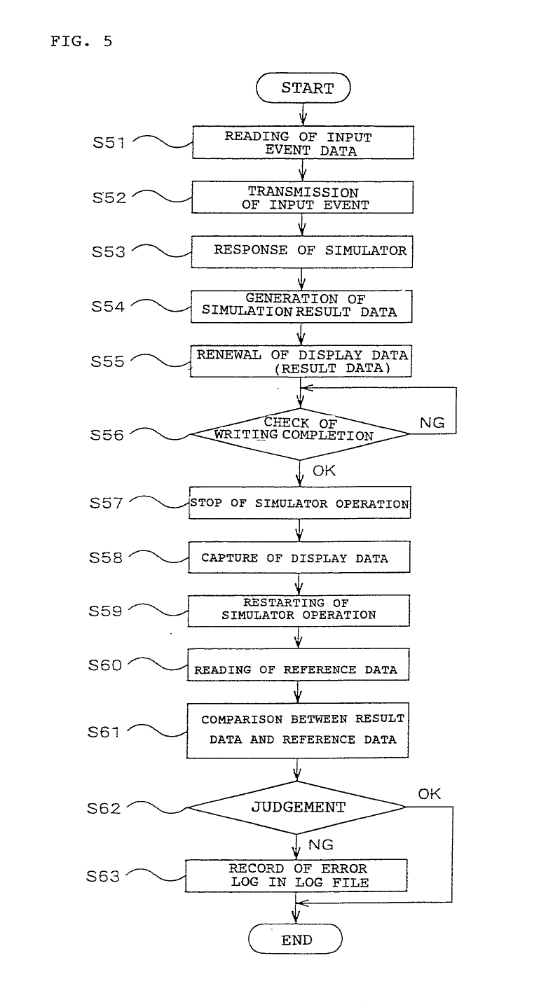

Now, a detailed description will be given of the determination of a simulation result of an automatic evaluation system 1. FIG. 4 is a function development view of a personal computer as an automatic evaluation system for realizing the automatic evaluation method, and FIG. 5 is a flowchart showing its operation procedure. In the drawings, blocks which are the same as those of FIG. 1 use the identical numerals.

In FIG. 4, the automatic evaluation system 1 of the embodiment is functionally roughly divided into an automatic evaluation unit 11 and a simulation unit 30. The simulation unit 30 includes a built-in simulator 3, and the simulator 3 simulates the operation of a program operating on a target system, and as described later, it monitors a timing when renewed data of an output screen on which its result is reflected becomes definite. The automatic evaluation unit 11 obtains, as described later, the timing when the renewed data of the output screen from the simulator 3 becomes definite, refers to the output screen at the timing, and compares the reference result with reference data prepared in advance so that the automatic evaluation is executed.

The simulation unit 30 is formed by a simulator 31 for performing the simulation and a timing monitor portion 32 for obtaining the timing when the renewed data of the output screen becomes definite by communicating with the simulator 31 through a RAM 10.

The timing monitor portion 32 is formed by any one of a timer 321, an arithmetic logic unit 322, and a decoder 323. The timer 321 monitors the passage of a predetermined time defined in advance to notify the automatic evaluation unit 11 that the simulation result becomes definite. The arithmetic logic unit 322 carries out a logical sum operation of individual simulation results corresponding to one input event at predetermined time intervals, and determines the finally prepared data to notify the automatic evaluation unit 11 that the simulation result becomes definite. The decoder 323 receives a display rewriting completion event (command) from a program (application program AP) operating on a target system (not shown), and decodes the display rewriting completion event to notify the automatic evaluation unit 11 that the simulation result becomes definite.

Hereinafter, the automatic evaluation method by the automatic evaluation system 1 of this embodiment shown in FIG. 4 will be described in detail with reference to the flowchart shown in FIG. 5.

The automatic evaluation unit 11 first reads out prepared input event data ID through the disk unit DU and captures it in the inside (step S51). Incidentally, the input event data ID includes specified information of a screen check point and reference data RD (file) at the point. Next, the captured input event is transmitted by an API command to the simulator 31 included in the simulation unit 30 (step S52). The simulator 31 responds to the input event (step S53), executes a simulation to generate result data (step S54), and renews the content of the RAM 10 (step S55).

The timing monitor portion 32 included in the simulation unit 30 monitors, at the same time as the generation of the result data by the simulator 31, a writing cycle of the result data, and here, it counts a predetermined time in advance to check whether writing of the simulation result is completed (step S56).

Incidentally, the timing monitor portion 32 continues to check until the writing is completed.

Then, the simulation unit 30 transmits a screen data rewriting completion notification to the automatic evaluation unit 11 after the completion of the writing, and stops the simulation (step S57). Then, the automatic evaluation unit 11 detects the completion of the writing by receiving the screen data rewriting completion notification from the simulation unit 30, and then, captures the simulation result data (screen display data) written in the RAM 10 (step S58). After the completion of the capturing, the automatic evaluation unit 11 transmits a screen data reading completion notification to the simulation unit 30. Then, after the reception of the screen data reading completion notification, the simulation unit 30 restarts the simulation (step S59). The automatic evaluation unit 11 reads the reference data RD (file) (step S60). Subsequently, the automatic evaluation unit 11 compares the reference data RD with the simulation result data (step S61). The automatic evaluation unit 11 determines whether the simulation result matches the reference data RD (step S62), and evaluates the operation of the application program AP of the input event. As a result, if they match, the automatic evaluation unit 11 ends the processing, and if they do not match, the automatic evaluation unit stores an error log in a log file (step S63).

Incidentally, although the description has been given of the case where the check of the writing completion (step S56) in the timing monitor portion 32 is performed through timer monitoring by the timer 321, it may be performed by the arithmetic logic unit 322 which carries out a logical sum operation of the individual simulation results for every predetermined time to one input event and determines the finally prepared data, or by the decoder 323 which receives the display rewriting completion event (command) from the program (application program AP) operating on the not-shown target system and decodes the display rewriting completion event. However, although the method of receiving the display rewriting completion event is certain, a part of the program on the target system is modified, and a burden is imposed on its development tool.

As described above, according to this automatic evaluation system 1, the access between the automatic evaluation system 1 and the simulator 3 is enabled by accessing the API commands and the RAM 10. Thus, it is not necessary to add a specific function to the automatic evaluation system 1 and the simulator 3 in order to transmit the input event from the automatic evaluation system 1 to the simulator 3 and to refer to the simulation result of the simulator 3 by the automatic evaluation system 1. Further, it is not necessary to incorporate a function for automatic evaluation in the application program AP, and the same one as an application program actually installed in a microcomputer may be used. Further, according to this automatic evaluation system 1, even in the case where the simulation result is changed irrespective of the key input in the blinking cursor or the like, since the timing monitor portion 32 monitors the simulation result, the automatic evaluation can be carried out by the definite simulation result.

The present invention is not limited to the foregoing actual mode, but can be carried out in various modes.

For example, although the API commands and the RAM are used for the communication between the automatic evaluation system 1 and the simulator 3, the invention is not limited to these means but may use other means.

Besides, although the automatic evaluation system l and the simulator 3 are formed on the same personal computer, they may be formed on another electronic computer such as a work station.

Besides, a structure may also be adopted in which an automatic evaluation program stored in another computer is downloaded into a personal computer forming an automatic evaluation system and a simulator through a network and is executed.

As described above, according to the present invention, access between the automatic evaluation system and the simulator can be made through the common memory, so that the automatic evaluation can be carried out by using the simulation result of the simulator for the input event, and at this time, the automatic evaluation system can capture the result data of the simulation only at the timing when the simulation result becomes definite even in any state. Accordingly, the stable reference data can be obtained, and the evaluation having high reliability becomes possible by this. Especially, a case where reference to simulation data is made during inversion of a blinking cursor or the like does not occur, and as a result, the stability in the automatic evaluation is secured.

Besides this, since the simulation is stopped when the reference to the output screen is made, the data of the output screen is not renewed by the simulation. Accordingly, it is possible to certainly refer to the output screen on which the data becomes definite.

1. An automatic evaluation method for automatically evaluating a program operating on a target system by referring to an output screen as a result of a simulation to an arbitrary input event, the automatic evaluation method characterized in that:
the simulation is performed, a timing when data renewal of the output screen on which its result is reflected becomes definite is reported, reference to the output screen is made in accordance with the timing, and
a result of the reference is compared with reference data prepared in advance so that an automatic evaluation is carried out.

2. An automatic evaluation method as set forth in claim 1, characterized in that the timing when the data renewal of the output screen becomes definite is determined by monitoring the passage of a predetermined time defined in advance.

3. An automatic evaluation method as set forth in claim 1, characterized in that the timing when the data renewal of the output screen becomes definite is determined based on data which is finally prepared by carrying out a logical sum operation of individual simulation results at predetermined intervals of time.

4. An automatic evaluation method as set forth in claim 1, characterized in that the timing when the data renewal of the output screen becomes definite is reported by a display rewriting completion event from the program operating on the target system.

5. An automatic evaluation method as set forth in any one of claims 1 to 4, characterized in that the simulation is stopped when reference to the output screen is made.

6. An automatic evaluation system for automatically evaluating a program operating on a target system by referring to an output screen as a result of a simulation corresponding to an arbitrary input event, the automatic evaluation system comprising:
a simulation unit for performing the simulation of an operation of the program and monitoring a timing when data renewal of the output screen on which its result is reflected becomes definite; and
an automatic evaluation unit for obtaining from the simulation unit the timing when the data renewal of the output screen becomes definite, referring to the output screen at the timing, and carrying out an automatic evaluation by comparing a result of the reference with reference data prepared in advance.

7. An automatic evaluation system as set forth in claim 6, characterized in that the simulation unit comprises:
a simulator for performing the simulation; and
a timing monitor portion for obtaining the timing when the data renewal of the output screen becomes definite by communicating with the simulator.

8. An automatic evaluation system as set forth in claim 7, characterized in that the timing monitor portion includes a timer for monitoring the passage of a predetermined time defined in advance.

9. An automatic evaluation system as set forth in claim 7, characterized in that the timing monitor portion includes an arithmetic logic unit for carrying out a logical sum operation of individual simulation results at predetermined time intervals and a determination according to the finally prepared data.

10. An automatic evaluation system as set forth in claim 7, characterized in that the timing monitor portion includes a decoder which receives a display rewriting completion event from the program operating on the target system and decodes the display rewriting completion event.

11. An automatic evaluation system as set forth in any one of claims 6 to 10, characterized in that the simulation is stopped when the reference to the output screen is made.

12. A storage medium storing an automatic evaluation program for automatically evaluating a program operating on a target system by referring to an output screen as a result of a simulation corresponding to an arbitrary input event, in which the automatic evaluation program comprises:
a step of reading an input event and reference data prepared in advance for the individual input event;
a step of successively transmitting the read input event to trigger execution of the simulation;
a step of obtaining a notification of a timing when data renewal of the output screen on which a result of the simulation is reflected becomes definite and referring to the output screen in accordance with the timing; and
a step of carrying out an automatic evaluation by comparing a result of the reference with the reference data.
